(19) United States
(12) Patent Application Publication
(10) Pub. No.: US 2019/0072250 A1
(43) Pub. Date: Mar. 7, 2019

(54) EMERGENCY LIGHT BULB

(71) Applicant: TTI (MACAO COMMERCIAL OFFSHORE) LIMITED, Macau (MO)

(72) Inventors: Mark Huggins, Anderson, SC (US); J. Porter Whitmire, Greenville, SC (US)

(21) Appl. No.: 16/116,235

(22) Filed: Aug. 29, 2018

Related U.S. Application Data
(60) Provisional application No. 62/553,519, filed on Sep. 1, 2017.

(51) Int. Cl. F21S 9/02; H05B 37/02; F21K 9/232; H05B 33/08; G08B 7/06; F21V 23/04

(52) U.S. Cl. CPC F21S 9/022; H05B 37/0272; F21K 9/232; F21Y 2115/10; H05B 33/0848; G08B 7/066; F21V 23/045; H05B 33/0854

(57) ABSTRACT

An emergency lighting system includes a control hub and an emergency light bulb. The control hub includes a battery, a controller, and a transmitter. The emergency light bulb includes a battery, a bulb controller, a receiver, and a light emitting element. The control hub is configured to detect a loss of power at a pair of AC contacts of the control hub. When the loss of power is determined, the control hub transmits a power control signal to the emergency bulb. The emergency light bulb is configured to receive the power control signal. Based on the power control signal, the emergency light bulb enables the light emitting element to receive power from the battery of the emergency light bulb.

### CROSS REFERENCE TO RELATED APPLICATIONS

This application claims priority benefit of U.S. Provisional Application No. 62/553,519, filed on Sep. 1, 2017, the entire contents of which are hereby incorporated.

### BACKGROUND

The present disclosure relates to emergency lighting systems. More specifically, the disclosure relates to emergency light bulbs responsive to determination of a loss or availability of power.

### SUMMARY

In one embodiment, the disclosure provides an emergency lighting system, including a control hub and an emergency light bulb. The control hub includes a battery, a controller, and a transmitter. The emergency light bulb includes a battery, a bulb controller, a receiver, and a light emitting element. The control hub is configured to determine a loss of power at a pair of AC contacts of the control hub. When the loss of power is determined, the control hub transmits a power control signal to the emergency bulb. The emergency light bulb is configured to receive the power control signal. Based on the power control signal, the emergency light bulb controls the light emitting element to receive power from the battery of the emergency light bulb.

In another embodiment, the control hub determines an availability of AC power at the pair of AC contacts of the control hub. The control hub transmits a power control signal to the emergency light bulb. Based on the power control signal, the light emitting element of the emergency light bulb is disconnected from the battery of the emergency light bulb. In some embodiments, the control hub includes a switch actuator configured to receive a user input and, in response, to transmit a power control signal. Other aspects of the disclosure will become apparent by consideration of the detailed description and accompanying drawings.

### BRIEF DESCRIPTION OF THE DRAWINGS

FIG. 1 illustrates an installation of an emergency lighting system including a control hub and an emergency light bulb.

FIG. 2 illustrates the control hub.

FIG. 3 illustrates the emergency light bulb.

FIG. 4 is a block diagram of the emergency lighting system.

FIG. 5 is a flow diagram of a first method of controlling the emergency lighting system.

FIG. 6 is a flow diagram of a second method of controlling the emergency lighting system.

FIG. 7 is a block diagram of the emergency lighting system according to another embodiment.

FIG. 8 is a circuit diagram for an electrical circuit configured to connect to the emergency lighting system 100.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

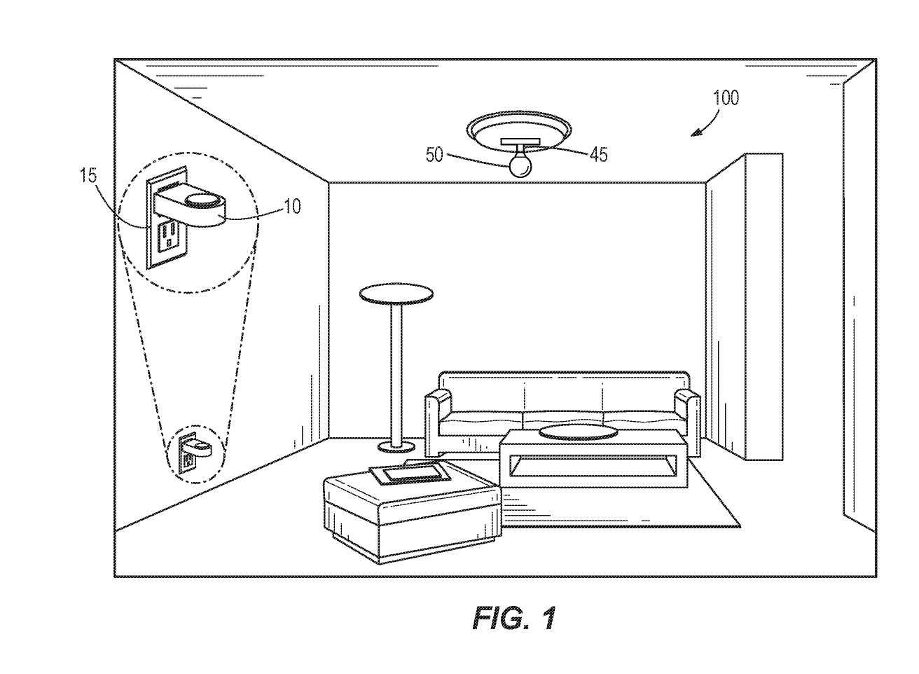

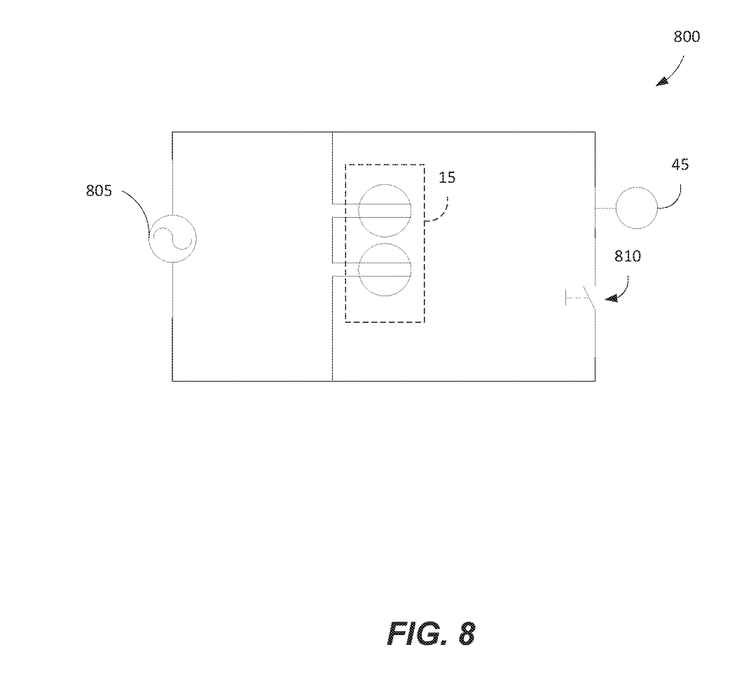

FIG. 1 illustrates an exemplary installation of an emergency lighting system 100 in a room. The emergency lighting system 100 includes a control hub 10 and one or more emergency light bulbs 50. The control hub 10 is coupled to an alternating current (AC) wall outlet 15 and the one or more emergency light bulbs 50 are coupled to respective AC sockets 45. The AC sockets 45 may further be coupled to a wall switch or pull chain switch that enables and disables the flow of AC power to the AC socket 45. The wall outlet 15 and the AC socket 45 are both ultimately coupled to the same AC power source, such as an AC utility grid. Accordingly, a power outage experienced at the wall outlet 15 will also be experienced at the AC socket 45. For example, FIG. 8 illustrates a circuit diagram 800 for an electrical circuit (e.g., of a room or building) configured to connect to the emergency lighting system 100. The circuit diagram 800 illustrates the connections between an AC utility grid 805, the AC wall outlet 15, the AC socket 45, and a wall switch 810 used to selectively enable and disable the flow of AC power to the AC socket 45.

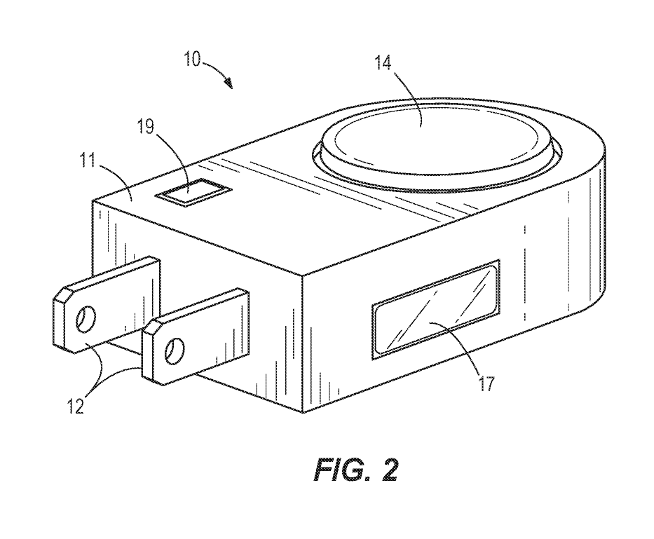

FIG. 2 illustrates one embodiment of the control hub 10, the control hub 10 having a housing 11 and a pair of AC contacts 12 configured to receive power from an AC power source such as, for example, the wall outlet 15. The control hub 10 includes a user input control 14, illustrated as a push button, supported by the housing 11. The control hub 10 may include additional user input controls 14, such as switches, dials, or touchpads. The control hub 10 further includes a status indicator 17, such as a light or a speaker, to indicate to a user a power status of the control hub 10. In some embodiments, the control hub 10 does not include the user input control 14, the status indicator 17, or both. The control hub 10 further includes a light sensor 19, such as a photodiode, to determine a level of ambient light. In some embodiments, the control hub 10 does not include the light sensor 19. Alternatively, or in addition, another sensor may be provided such as an occupancy detector or motion sensor.

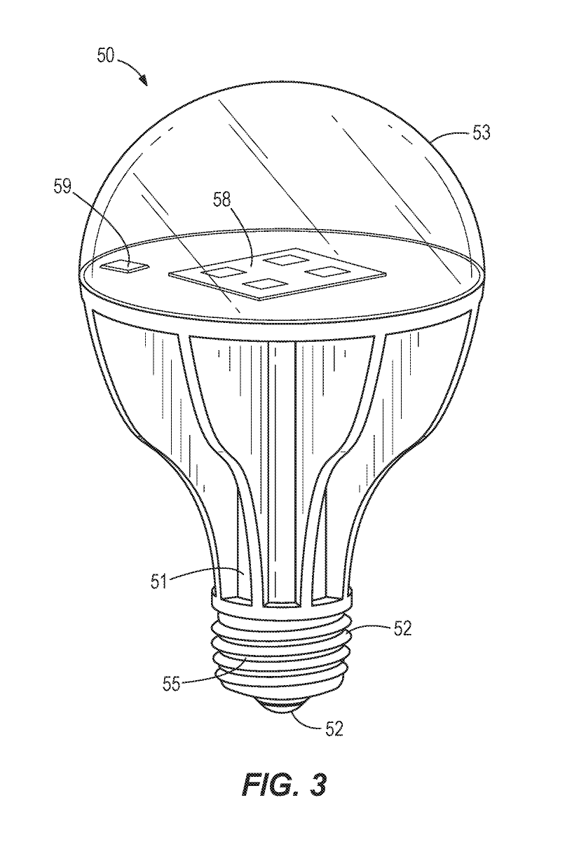

FIG. 3 illustrates one embodiment of the emergency light bulb 50. The emergency light bulb 50 includes a housing 51, a light emitting element 58 supported by the housing 51, and a base 55. The base 55 is threaded and supports the housing 51 in a socket (e.g., of a conventional AC light fixture) and provides a pair of AC contacts 52 to deliver power to the light emitting element 58. The light emitting element 58 includes one or more LEDs configured to emit light. In some embodiments, the light emitting element 58 may be configured to selectively emit light at more than one light level such as, for example, a first light level and a second, lower light level. A lens 53, supported by the housing 51, surrounds and protects the light emitting element 58 and may be used to grasp the emergency light bulb 50 during installation. The light bulb 50 further includes a light sensor 59, such as a photodiode, for determining a level of ambient light. In some embodiments, the light bulb 50 does not include the light sensor 59. While the light bulb 50 is illustrated such that the base 55 is a generally cylindrically-shaped stem and the lens 53 is a round, enlarged bulb-shaped end, in some embodiments, the light bulb 50 has a different shape. Accordingly, “bulb” in the element name “light bulb” is not intended to convey a particular shape.

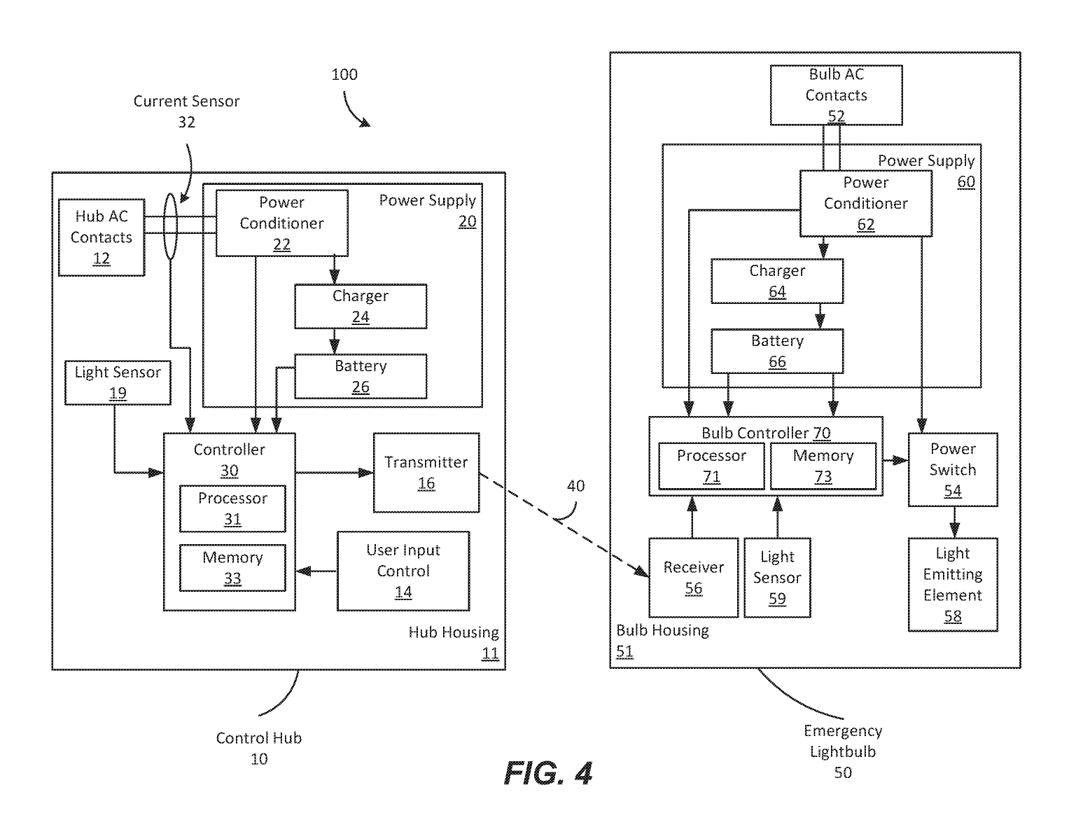

FIG. 4 depicts a block diagram of the emergency lighting system 100 including the control hub 10 and the emergency light bulb 50. Within the housing 11, the control hub 10 includes a controller 30, a transmitter 16 coupled to the controller 30, and a power supply 20. The power supply 20 of the control hub 10 is coupled to the AC contacts 12 and configured to selectively deliver power to the controller 30. In some embodiments, the controller 30 includes an electronic processor 31 coupled to a memory 33 storing instructions that are retrieved and executed by the electronic processor 31 to carry out the functionality of the controller 30 described herein. The power supply 20 receives power at a power conditioner 22 configured to rectify AC power and provide regulated DC power. The power conditioner 22 is coupled to a battery charger 24 configured to charge a battery 26 supported within the housing 11. When AC power is received at the AC contacts 12, the power conditioner 22 provides DC power to the controller 30 as well as the charger 24. When AC power is not received at the AC contacts 12, the battery 26 provides DC power to the controller 30.

The controller 30 is coupled to a current sensor 32 configured for determining the reception of AC power at the AC contacts 12. The current sensor 32 is, for example, a non-contact sensor, such as a current transformer. The controller 30 is further coupled to a radio-frequency transmitter 16 configured for wirelessly transmitting power control signal or messages 40 using a wireless communication protocol such as, for example, Wi-Fi, RFID, ZigBee, Bluetooth, or the like. In some embodiments, the transmitter 16 is an infrared transmitter, rather than a radio-frequency transmitter. In some embodiments, the controller 30 may receive a user input from the user input control 14. In some embodiments, the controller 30 is further coupled to the light sensor 19, the light sensor 19 configured to determine and indicate to the controller 30 a level of ambient light. The controller 30 is configured to transmit one or more power control signals 40 based, at least in part, on the determination of AC power at the AC contacts 12 and the user input from the user input control 14. In further embodiments, the controller 30 is configured to transmit one or more power control signals 40 based, at least in part, on the determination of the level of ambient light.

The emergency light bulb 50 includes a power supply 60 configured to receive power from the AC contacts 52 and deliver power to a bulb controller 70 and a power switch 54. In some embodiments, the bulb controller 70 includes an electronic processor 71 coupled to a memory 73 storing instructions that are retrieved and executed by the electronic processor 71 to carry out the functionality of the bulb controller 70 described herein. The power supply 60 receives AC power from the AC contacts 52 at a power conditioner 62 configured to rectify AC power and provide regulated DC power. The power conditioner 62 is coupled to a battery charger 64 configured to charge a battery 66 within the bulb housing 51. When AC power is received at the AC contacts 52, the power conditioner 62 provides DC power to the bulb controller 70, the charger 64, and the power switch 54. When AC power is not received at the AC contacts 52, the battery 66 provides power to the controller 70 and the power switch 54.

The bulb controller 70 is coupled to a wireless receiver 56 configured for receiving the power control signal 40. The controller 70 controls the power switch 54 to selectively provide power to the light emitting element 58. In some embodiments, the controller 70 controls the power switch 54 to selectively provide power to individual LEDs of the light emitting element 58. In some embodiments, the power delivered by the power switch 54 causes the light emitting element 58 to emit light at a normal light level or a low-power light level. In some embodiments, the controller 70 is further coupled to the light sensor 59, the light sensor 59 configured to determine and indicate to the controller 70 a level of ambient light. In further embodiments, the controller 70 controls the power switch 54 to selectively provide power to individual LEDs of the light emitting element 58 based, at least in part, on the determination of the level of ambient light. Alternatively, or in addition, the emergency light bulb 50 may include another sensor, such as an occupancy detector or motion sensor. In such embodiments, the controller 70 controls the power switch 54 to selectively provide power to the individual LEDs of the light emitting element 58 based, at least in part, on data received from the other sensor(s).

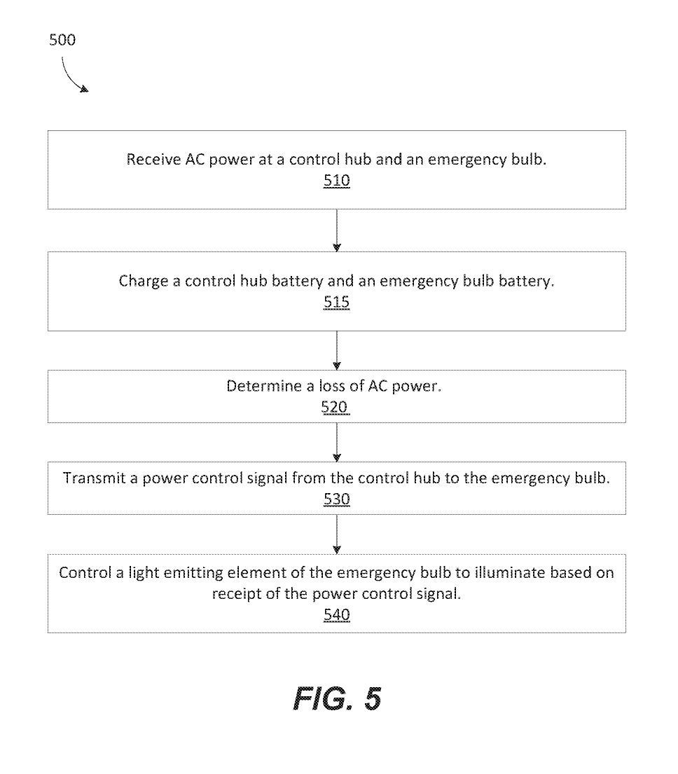

FIG. 5 provides a method 500 of controlling an emergency light system, such as the emergency lighting system 100. In block 510, the control hub 10 receives AC power at the AC contacts 12 from a wall outlet and the emergency light bulb 50 receives AC power at the AC contacts 52 from a light socket. In block 515, the power conditioner 22 conditions the received AC power from the AC contacts 12 and provides DC power to the charger 24, which charges the battery 26. Additionally, in block 515, the power conditioner 62 conditions the received AC power from the AC contacts 52 and provides DC power to the charger 64, which charges the battery 66. In block 520, the controller 30 determines a loss of AC power at the AC contacts 12 based on an output of the current sensor 32. For example, in response to a power outage at the wall outlet 15, AC current will cease to flow via the AC contacts 12, and the current sensor 32 will output a signal to the controller 30 indicating a loss of AC power. In response to the power outage, the controller 30 is powered by the battery 26, for example, by closing a switch connecting the controller 30 to the battery 26. Additionally, in response to the loss of AC power at the bulb AC contacts 52, whether from the power outage or turning off an associated wall switch, the power supply 60 provides the bulb controller 70 with power from the battery 66, for example, by closing a switch connecting the bulb controller 70 to the battery 66.

In block 530, controller 30, now powered by the battery 26, controls the transmitter 16 to transmit a first power control signal 40 to the receiver 56. The first power control signal 40 may include a data message indicating one or more of a power outage, an identity of the control hub 10, and an identity of the emergency light bulb 50.

In block 540, the bulb controller 70 controls the light emitting element 58 to illuminate based on receipt of the first power control signal 40. More particularly, responsive to receiving the first power control signal 40 at the receiver 56, the controller 70, now receiving power from the battery 66, controls the power switch 54 to deliver power from the battery 66 to the light emitting element 58. In some embodiments, responsive to the first power control signal 40, the controller 70 controls the power switch 54 to deliver power at a second light level that is lower than a first light level provided by the emergency light bulb 50 in other operation modes. For example, the controller 70 is configured, in some embodiments, to provide a pulse-width modulated (PWM) signal to the power switch 54. The PWM signal has a duty ratio that controls the percentage of time that the power switch 54 couples the light emitting element 58 to a power source (e.g., an output of the battery 66 or the power conditioner 62) and, thereby, the light level of the light emitting element 58.

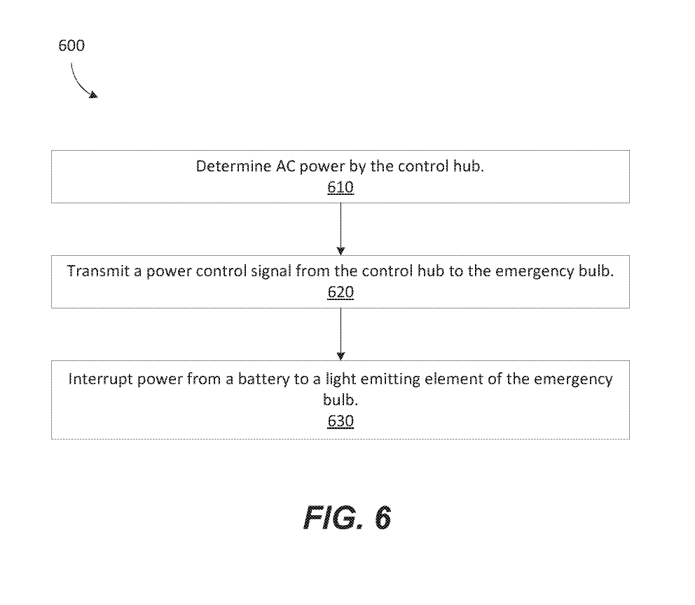

FIG. 6 provides a method 600 of controlling an emergency lighting system, such as the emergency lighting system 100. In some embodiments, the method 600 is executed after step 540 of the method 500. In block 610, the controller 30 determines AC power at the hub AC contacts 12 based on an output from the current sensor 32. For example, the controller 30 determines when power is restored at the wall outlet 15 after a power outage. Upon the restoration of AC power and receiving AC power at the hub AC contacts 12, the power supply 20 may supply the controller 30 with power from the power conditioner 22 and the power conditioner may also supply power to the charger 24 to charge the battery 26.

In block 620, the controller 30 controls the transmitter 16 to transmit a second power control signal 40 to the receiver 56. The second power control signal 40 may include a data message indicating one or more of a power restoration, an identity of the control hub 10, and an identity of the emergency light bulb 50.

In block 630, responsive to receiving the second power control signal 40 at the receiver 56, the controller 70 controls the power switch 54 to interrupt the delivery of power from the battery 66 to the light emitting element 58. Accordingly, the light emitting element 58 is disconnected from the battery 66 based on the second power control signal 40. In some embodiments, responsive to the second power control signal 40, the controller 70 controls the power switch 54 to transfer the source of power delivered to the light emitting element 58 from the battery 66 to the power conditioner 62. In some embodiments, after block 630, the emergency light system 100 returns to block 510 of the method 500.

In some embodiments of the method 500, the controller 30 of the control hub 10 receives a signal from the user input control 14 in response to a user input. For example, while the control hub 10 is attached to the wall outlet 15, the signal may be generated in response to user input at the user input control 14 that occurs between blocks 510 and 520 of the method 500. In another example, the control hub 10 may be disconnected from the wall outlet by a user first, and then the signal is generated in response to user input at the user input control 14 (for example, after block 520). In this instance, the control hub 10 is no longer receiving AC power, but power supplied from the battery 26 enables the control hub 10. In response to the signal from the user input control 14, the controller 30 generates the power control signal 40. Responsive to the power control signal 40, the controller 70 may control the power switch 54 to disconnect or transfer the source of power delivered to the light emitting element 58 (between the power conditioner 62 and the battery 66), or may control the power switch 54 to selectively deliver power to the light emitting element 58 at one of a plurality of light levels. Thus, whether coupled to the wall outlet 15 or removed therefrom, the control hub 10 may function as a wireless remote to control the emergency light bulb 50 to cycle on and off and to cycle among various light levels.

Accordingly, the control hub 10 may be used as a portable wireless remote, operable to control one or more emergency light bulbs 50. Similarly, the emergency light bulb 50 may be controlled by one or more control hubs 10.

In some embodiments, in block 510 of method 500, AC power is not being received at the emergency light bulb 50. For example, AC power is not received by the emergency light bulb 50 when a light switch coupled to the AC socket 45 is in an off position, even though AC power is available at the wall outlet 15.

In some embodiments, of the emergency lighting system 100, the charger 24 is not included in the control hub 10 to charge the battery 26, the charger 64 is not included in the emergency light bulb 50 to charge the battery 66, or both the charger 24 and the charger 64 are not included in the control hub 10 and the emergency light bulb 50, respectively. In such devices without a charger, the battery is not charged and is, for example, a primary battery that is not rechargeable. When such battery is depleted, the battery may be replaced by a user. In some embodiments, one or both of the control hub 10 and the emergency light bulb 50 include both a rechargeable (secondary) battery and non-rechargeable (primary) battery. In other embodiments, the control hub 10, the emergency light bulb 50, or both, are not particularly configured (e.g., with a battery access door) for replacing batteries and, rather, are replaced as a unit upon depletion of the associated battery.

In some embodiments of the method 500, the controller 30 may further control the transmitter 16 based, at least in part, on a determination of ambient light by the light sensor 19. For example, in response to a signal to the controller 30 indicating a loss of power and a signal to the controller 30 indicating an ambient light level beyond a light level threshold, the controller 30 controls the transmitter 16 to modify the data message included in the first power control signal 40 to indicate that ambient light level is above the light level threshold or delays transmission of the first power control signal 40 until the ambient light level falls below the light level threshold. Thus, the controller 30 may control the emergency light bulb 50 to turn on at a first (lower) level of ambient light and turn off at a second (higher) level of ambient light. Additionally, the controller 30 may control the emergency light bulb 50 to emit light at a low-power level at an intermediate level of ambient light. Accordingly, when sufficient ambient light is present to render emergency lighting less helpful, for example, energy usage of the emergency light bulb 50 is reduced and the length of time that emergency lighting can be provided is increased.

In some embodiments of the method 500, the controller 70 may further control the light emitting element 58 based, at least in part, on a determination of ambient light by the light sensor 59. For example, responsive to the controller 70 receiving the first power control signal 40 and a signal from the light sensor 59 indicating an ambient light level below a light level threshold, the controller 70 controls the power switch 54 to deliver power to the light emitting element 58. However, responsive to the controller 70 receiving the first power control signal 40 and a signal from the light sensor 59 indicating an ambient light level above a light level threshold, the controller 70 controls the power switch 54 to not deliver power to the light emitting element 58. Thus, the controller 70 may control the light emitting element 58 to turn on at the first (lower) level of ambient light and turn off at the second (higher) level of ambient light. Additionally, the controller 70 may control the light emitting element 58 to emit light at a low-power level at the intermediate level of ambient light. Accordingly, when sufficient ambient light is present to render emergency lighting less helpful, for example, energy usage of the emergency light bulb 50 is reduced and the length of time that emergency lighting can be provided is increased.

In some embodiments of the methods 500 and 700, the controller 70 may be configured to control the light emitting element based, at least in part, on data received from another sensor, such as an occupancy detector or motion sensor. For example, responsive to the controller 70 receiving the first power control signal 40 and a signal from a motion sensor indicating motion beyond a motion threshold, the controller 70 controls the power switch 54 to deliver power to the light emitting element 58. However, responsive to the controller 70 receiving the first power control signal 40 and a signal from the motion sensor that indicates motion below a motion threshold (e.g., indicating a lack of detected motion), the controller 70 controls the power switch 54 to not deliver power to the light emitting element 58. Thus, the controller 70 may control the light emitting element 58 to turn on at the first (higher) level of detected motion. Alternatively, or in addition, the controller 70 may control the light emitting element 58 based on both the light sensor 59 and an additional sensor, such as the motion sensor. For example, the controller 70 may control the light emitting element 58 to turn on or deliver light at a higher light level when both an ambient light threshold and a motion threshold have been met.

In some embodiments of the method 500 and 600, the controller 70 may be configured for a (first) low power operating state having lower power requirements than a (second) normal operating state. For example, the low power operating state may be a standby state in which the controller 70 consumes less power to extend battery life of the battery 66. For example, between blocks 510 and 530 or between blocks 610 and 620, the controller 30 controls the transmitter 16 to transmit a third (wake-up) power control signal 40 to the receiver 56. The third power control signal 40 includes a data message indicating one or more of a request for a power state transition by the controller 70 (e.g., from the low power state to the normal operating state), an identity of the control hub 10, and an identity of the emergency light bulb 50. Accordingly, responsive to receiving the third power signal 40 at the receiver 56, the controller 70 transitions between the low power operating state and the normal operating state. In some embodiments, after a certain period of inactivity, the controller 70 may transition back to the low power operating state. In some embodiments, the period of inactivity may be determined based on a data received from a motion sensor.

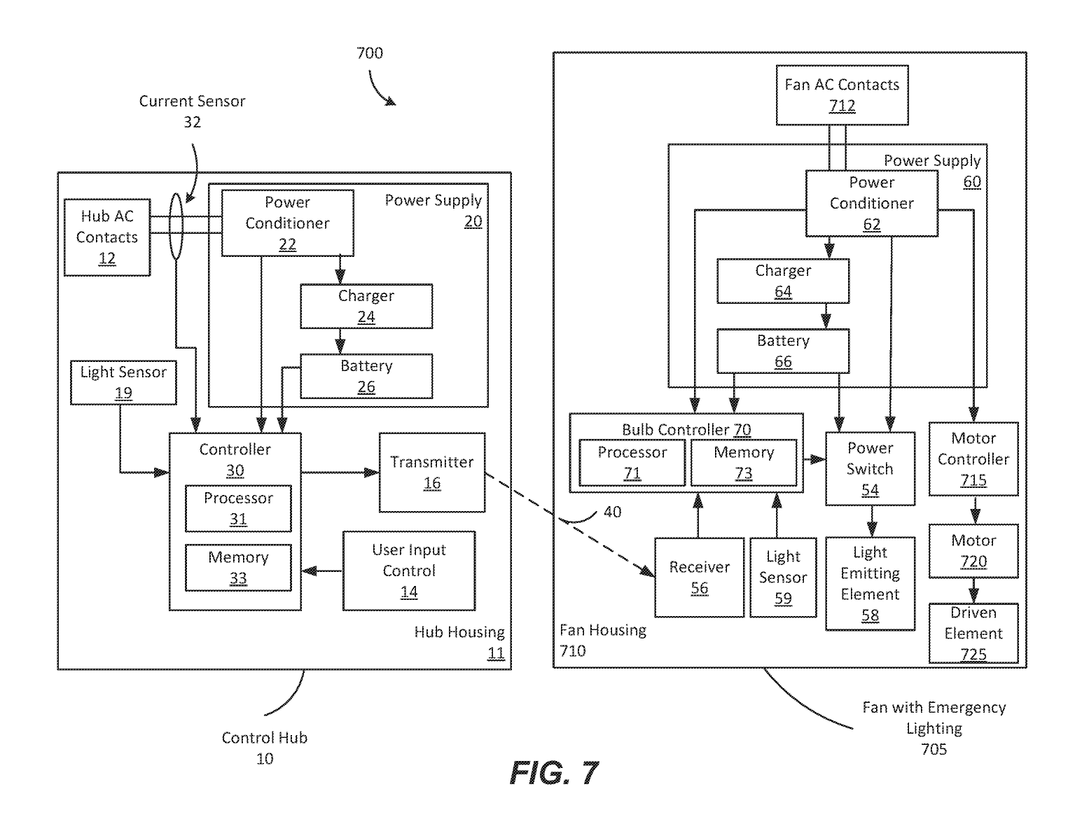

In some embodiments, an illuminating fan or other motorized device with lighting is incorporated into the emergency lighting system 100, such as shown in FIG. 7. More particularly, FIG. 7 illustrates an emergency lighting system 700, which is similar to the emergency lighting system 100 but for the incorporation of the emergency lighting feature into a motorized product, illustrated as a fan with emergency lighting 705. Given the similarities between the emergency lighting system 10 and the emergency lighting system 700, like numbered elements of the embodiments have similar functionality as described above and the description of these elements is not repeated.

The fan with emergency lighting 750 includes a fan housing 710, fan AC contacts 712, a motor controller 715, a motor 720, and a driven element 725. The fan with emergency lighting 705 may take the form of a ceiling fan or a standing fan. In the case of a ceiling fan, the fan AC contacts may include wire leads coupled to power wires of a ceiling outlet receptacle, and the fan housing 710 may further include a mounting bracket to secure the fan housing 710 to the powered ceiling outlet fixture. In the case of a standing fan, the fan AC contacts 712 are terminals coupled to a corded plug configured to be attached to a standard wall outlet.

The motor controller 715 receives power from the power supply 60, as illustrated, and selectively provides power to the motor 720. The motor 720 converts the received power to mechanical, rotational output to drive the driven element 725. The driven element 725 includes fan blades. When power is present at the fan AC contacts 712 and the fan is enabled via, for example, an on-off switch (not shown), the motor 720 drives the driven element 725 to produce an airflow within an area in which the fan is positioned. During a power outage of the AC supply providing power to the fan AC contacts 712, the fan functionality provided by the motor 720 is disabled and unavailable. However, the fan with emergency lighting 705 is operable to provide emergency lighting in the same manner as the emergency light bulb 50 described above (see, for example, the methods 500 and 600 of FIGS. 5 and 6, respectively).

In some embodiments of the emergency lighting system 700, the fan with emergency lighting 705 takes the form of another motorized product having lighting elements.

Thus, the disclosure provides, among other things, an emergency lighting system.

What is claimed is:

1. An emergency lighting system, comprising:
a control hub including:
a hub battery,
a wireless transmitter,
a pair of AC contacts, and
a controller including an electronic processor and a memory, the controller configured to:
determine a loss of power at the AC contacts, and
transmit a power control signal, via the transmitter, in response to determining the loss of power; and
a light bulb including:
a bulb battery,
a light emitting element,
a wireless receiver,
a bulb controller including an electronic processor and a memory, the bulb controller configured to:
receive, via the receiver, the power control signal transmitted by the controller, and
control the light emitting element to receive power from the bulb battery of the light bulb based on the power control signal.

2. The emergency lighting system of claim 1,
wherein the control hub further comprises a user input control, and
wherein the controller is further configured to:
receive a user input at the user input control, and
transmit, via the transmitter, a second power control signal in response to receiving the user input, and
wherein the bulb controller is further configured to:
receive, via the receiver, the second power control signal transmitted by the controller, and
control the light emitting element to receive power from the bulb battery of the light bulb based on the second power control signal.

3. The emergency lighting system of claim 1,
wherein the control hub further comprises an ambient light sensor, and
wherein the controller is further configured to determine, with the ambient light sensor, an ambient light level, and
wherein the power control signal transmitted by the controller is based on the ambient light level determined with the ambient light sensor.

4. The emergency lighting system of claim 1, wherein the light bulb further comprises:
a housing supporting the light emitting element, and
a pair of AC contacts supported by the housing.

5. The emergency lighting system of claim 4, wherein the bulb controller is further configured to:
determine an availability of AC power at the pair of AC contacts supported by the housing, and
control charging of the bulb battery of the light bulb in response to determining the availability of AC power.

6. The emergency lighting system of claim 5,
wherein the light bulb further comprises an ambient light sensor, and
wherein the bulb controller is further configured to:
determine, with the ambient light sensor, an ambient light level, and
control the light emitting element to emit light based on the determined ambient light level and the determination of the availability of AC power.

7. The emergency lighting system of claim 1, wherein the power control signal comprises at least one selected from the group of: an indication of a power outage, an identity of the control hub, and an identity of the light bulb.

8. The emergency lighting system of claim 1,
wherein the control hub further comprises a status indicator, and
wherein the controller is further configured to indicate, via the status indicator, a power status of the control hub.

9. The emergency lighting system of claim 1,
wherein the controller is further configured to:
determine an availability of AC power at the pair of AC contacts upon power returning after the loss of AC power is determined, and
transmit a second power control signal, via the transmitter, in response to determining an availability of AC power at the pair of AC contacts, and
wherein the bulb controller is further configured to:
receive, via the receiver, the second power control signal transmitted by the controller, and
interrupt power from the bulb battery to the light emitting element based on receiving the second power control signal.

10. The emergency lighting system of claim 1, further comprising a fan having a housing that houses a motor configured to drive a fan blade, the battery, the light emitting element, the wireless receiver, and the bulb controller.

11. A method of controlling an emergency light bulb system, comprising:
receiving AC power at a pair of AC contacts of a control hub;
receiving AC power at a pair of AC contacts of a light bulb;
determining, by a controller of the control hub, a loss of AC power at the control hub;
transmitting, wirelessly from the control hub, a first power control signal in response to determining the loss of AC power at the control hub;
receiving, at the light bulb, the first power control signal; and
controlling, by a bulb controller of the light bulb, a light emitting element of the light bulb based on receiving the first power control signal.

12. The method of claim 11, further comprising:
receiving, at a user input control of the control hub, a user input;
transmitting, wirelessly from the control hub, a second power control signal in response to receiving the user input;
receiving, at the light bulb, the second power control signal; and
controlling, by the bulb controller of the light bulb, the light emitting element of the light bulb based on receiving the second power control signal.

13. The method of claim 11, further comprising:
determining, with an ambient light sensor of the control hub, an ambient light level, wherein the power control signal transmitted by the controller indicates that the ambient light level is below a light level threshold.

14. The method of claim 11, wherein the light bulb further comprises:
a housing supporting the light emitting element, and
a pair of AC contacts supported by the housing.

15. The method of claim 14, further comprising:
determining, with the pair of AC contacts of the light bulb, an availability of AC power; and
controlling charging of a bulb battery of the light bulb in response to determining the availability of AC power.

16. The method of claim 15, further comprising:
determining, with an ambient light sensor of the light bulb, an ambient light level; and
controlling the light emitting element to emit light based on the determined ambient light level and the determination of the availability of AC power.

17. The method of claim 11, wherein the power control signal comprises at least one selected from the group of: an indication of a power outage, an identity of the control hub, and an identity of the light bulb.

18. The method of claim 11, further comprising:
indicating, with a status indicator of the control hub, a power status of the control hub.

19. The method of claim 11, further comprising:
determining an availability of AC power at the pair of AC contacts upon power returning after the loss of AC power is determined;
transmitting, wirelessly from the control hub, a second power control signal in response to determining an availability of AC power at the pair of AC contacts;
receiving, at the light bulb, the second power control signal; and
interrupting power from the bulb battery to the light emitting element based on receiving the second power control signal.

20. The method of claim 11, further comprising:
determining, by the controller with an ambient light sensor, an ambient light level, wherein transmitting, from the control hub, the first power control signal is further in response to the ambient light level determined by the controller.
